(19) United States
(12) Patent Application Publication
(10) Pub. No.: US 2006/0277572 A1
(43) Pub. Date: Dec. 7, 2006

(54) Digital television and control method of changing a channel thereof

(75) Inventor: Duk-jin Kang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/395,321

(22) Filed: Apr. 3, 2006

(30) Foreign Application Priority Data
Jun. 7, 2005 (KR) 2005-0048611

(51) Int. Cl. H04N 7/16; H04N 7/173; G06F 13/00; H04N 5/445; G06F 3/00

(52) U.S. Cl. 725/38; 725/37; 725/100; 725/131; 725/139

(57) ABSTRACT

Apparatuses and methods of changing a digital television channel on the basis of DCCT information include generating a GUI for inputting user-set information concerning the DCCT according to a predetermined time; storing the input user-set information according to time; and comparing the DCCT information with the user-set information, and changing to a predetermined channel based on the DCCT information if the DCCT information is equal to the user-set information. Thus, a digital television is provided with a method of changing a channel thereof, in which user-set information concerning a DCCT can be set in various ways according to time, thereby improving a user's convenience.

### CROSS-REFERENCE TO RELATED APPLICATIONS

This application claims the benefit of Korean Patent Application No. 2005-0048611, filed on Jun. 7, 2005, in the Korean Intellectual Property Office, the disclosure of which is incorporated herein by reference.

### BACKGROUND OF THE INVENTION

1. Field of the Invention

Apparatuses and methods consistent with the present invention relate to a digital television and a method for changing a channel thereof, and more particularly, to a digital television and a method for changing a channel based on a direct channel change table (DCCT).

2. Description of the Related Art

Digital broadcasting has recently begun. As compared with analog broadcasting, in digital broadcasting a video signal and an audio signal are converted into digital signals, and then those digital signals are compressed, packetized and transmitted as a transport stream.

Digital broadcasting standards are selected to be adapted to a variety of countries, respectively. A DCCT has been proposed as an extended standard for the program and system information protocol (PSIP) of the advanced television systems committee (ATSC) standard selected in North America.

Here, the DCCT is a table having information concerning how to automatically change a channel under certain conditions, and is transmitted by being included in the PSIP. According to the DCCT, items taken as channel change conditions are tabulated using codes. For example, these items can include local information, population information, genre information, etc. Further, setting information corresponding to such items is set in a television by a user.

When a digital television receives DCCT information, the received DCCT information is compared with the previously set DCCT-related information. In the case where the received DCCT information is equal to the previously set DCCT information, the channel is changed according to the DCCT information.

However, a user's favorite channel may vary according to time, and the users watching television may differ according to time. Therefore, the DCCT may cause a channel to be changed undesirably thereby inconveniencing a user.

### SUMMARY OF THE INVENTION

Accordingly, it is an aspect of the present invention to provide a digital television and a method of changing a channel thereof, in which information concerning a DCCT can be set by a user according to time, thereby improving a user's convenience.

The foregoing and/or other aspects of the present invention can achieved by providing a method of changing a digital television channel on the basis of DCCT information. The method includes generating a GUI for inputting user setting information concerning the DCCT according to a predetermined time; storing the input user setting information according to time; and comparing the DCCT information with the user setting information according to the time, and changing to a predetermined channel based on the DCCT information when the DCCT information is equal to the user setting information.

According to an aspect of the present invention, the GUI is generated to include a time axis to allow the user setting information to be input according to time based on predetermined information.

According to an aspect of the present invention, the GUI is generated allowing the user setting information to be input according to time based on the DCCT information.

According to an aspect of the present invention, the GUI is generated allowing the user setting information to be input according to time based on information in an event information table (EIT).

The foregoing and/or other aspects of the present invention can achieved by providing a digital television that includes a receiver configured to receive data, and a decoder configured to decode the received data, the digital television further including a GUI generator configured to generate a DCCT set menu allowing user setting information about the DCCT to be input based on a predetermined time; and a controller configured to compare input DCCT information with the input user setting information according to time, and operate to change to a predetermined channel based on the DCCT information if the DCCT information is equal to the user setting information.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a control block diagram of a digital television according to a first embodiment of the present invention;

FIG. 2 is a control flowchart of the digital television according to the first embodiment of the present invention;

FIG. 3 illustrates a DCCT set menu according to the first embodiment of the present invention; and

FIG. 4 illustrates a DCCT transmitted to the digital television according to the first embodiment of the present invention; and

FIG. 5 is a control flowchart of a digital television according to a second embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

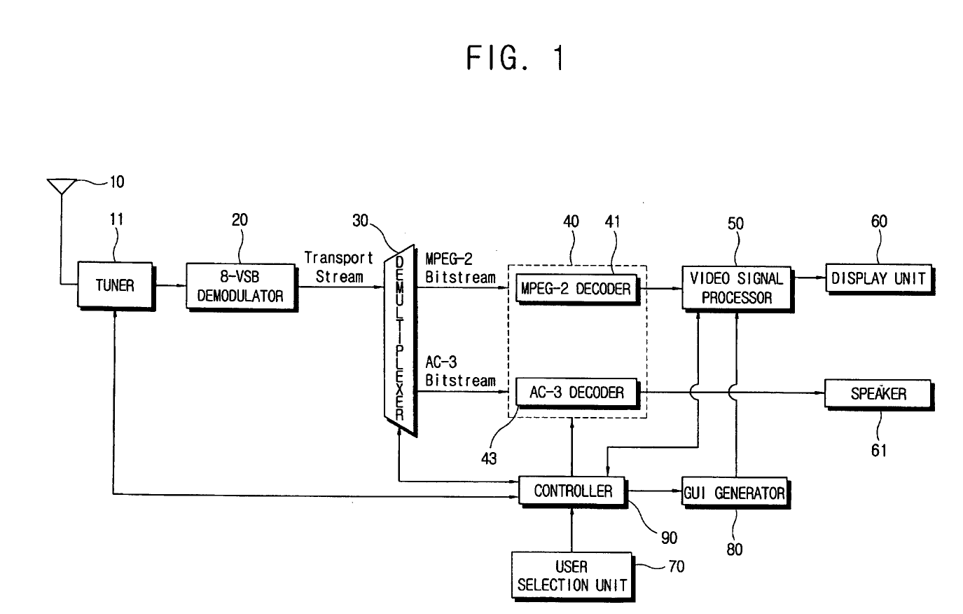

FIG. 1 is a control block diagram of a digital television according to a first embodiment of the present invention. For reference, the digital television according to the first embodiment of the present invention receives a broadcasting signal based on the ATSC standard.

As shown in FIG. 1, the digital television according to an embodiment of the present includes an antenna 10, a tuner 11, a 8-vestigial sideband (VSB) demodulator 20, a demultiplexer 30, a decoder 40, a video signal processor 50, a display unit 60, a speaker 61, a graphic user interface (GUI) generator 80, a user selection unit 70, and a controller 90.

A digital broadcasting signal is transmitted by time-division multiplexing and packetizing a video signal, an audio signal and data information into a transport stream.

The tuner 11 receives the broadcast signal received through antenna 10 and tunes the digital television to a broadcasting signal having a frequency band corresponding to a tuning control signal of the controller 90 (to be described later).

The broadcast signal of the channel to which the television is tuned is output by the 8-VSB demodulator 30 as the transport stream through a VSB demodulating process, an error correcting process, or the like. Then, the demultiplexer 30 divides the broadcast signal into a video signal, an audio signal and various appendix data such as PSIP information, and outputs them as a bit stream.

The video data divided by the demultiplexer 30 i,s decoded by a moving picture experts group (MPEG)-2 decoder 41, and processed by the video signal processor 50, thereby being displayed on the display unit 60. Here, the display unit 60 can employ various types of display technologies such as digital light processing (DLP), liquid crystal display (LCD), plasma display panel (PDP), etc. Further, the video signal processor 50 includes a scaler for converting the video signal so it has the appropriate vertical frequency, resolution, aspect ratio, etc. according to the output standards for the display unit 60.

Further, the audio signal is decoded by an audio coding (AC)-3 decoder 43, and output to the speaker 61.

Meanwhile, various appendix data included in the PSIP information divided by the demultiplexer 30 is stored in a predetermined memory (not shown) by a controller 90 according to data tables. Among the appendix data, data for displaying an image is processed through the video signal processor 50, synthesized with a currently tuned video signal, and output to the display unit 60 under control of the controller 90. Alternatively, the appendix data is generated as a video signal by the GUI generator 80 (to be described later), and processed by the video signal processor 50 under control of the controller 90.

Here, the PSIP information basically includes a system time table (STT), a master guide table (MGT), a virtual channel table (VCT), a rating region table (RRT), an event information table (EIT), and an ETT (extended text table). The PSIP information also includes a DCCT.

The user selection unit 70 is provided for allowing a user to select/cancel a DCCT function, and input user setting information about the DCCT. Here, the user selection unit 70 can include a menu key provided in a wireless remote controller, and a key signal generator generating a key signal corresponding to key manipulation. Alternatively, the user selection unit 70 may be achieved by way of a mouse, a keyboard, etc. or provided as a main panel of the digital television.

The GUI generator 80 generates a DCCT set menu to input information a user sets concerning the DCCT under control of a microcomputer (to be described later). Here, the DCCT set menu generated by the GUI generator 80 includes a time axis for facilitating input of the user-set information concerning the DCCT. Further, the GUI generator 80 divides the time axis under control of the controller 90, and allows the user-set information concerning the DCCT to be input according to the divided time axis. Here, the time axis can be divided based on the DCCT information or the EIT information included as the appendix data in the PSIP information.

In the DCCT set menu, the controller divides the time axis according to program start and end times specified in the DCCT information or the EIT information, thereby allowing a time-based input to be possible. Alternatively, the time axis may be divided by fixed time intervals of, for example, 30 minutes, 1 hour or the like without considering the DCCT or EIT information, thereby allowing for the possibility of time-based input. Further, the time axis may be freely divided by operating the user selection unit 70.

The user setting information about the DCCT includes postal code information, local information, population information, and genre information, which is included in the DCCT. Here, the local information includes a country code, a regional code, and a detailed regional code. Also, the population information includes information about gender, ages, occupations, etc. Such a DCCT set menu is synthesized with a video signal currently processed through the video signal processor 50, and displayed on the display unit 60.

The controller 90 receives a key signal from the user selection unit 70 and controls a function corresponding to the key signal to be performed. Here, a microcomputer or the like can be used for the controller 90.

When the DCCT function is selected by use of the user selection unit 70, the controller 90 controls the GUI generator 80 to generate the DCCT set menu allowing a user to divide the user setting information about the DCCT according to a predetermined time, and to input and select the user setting information.

As described above, the controller 90 controls the GUI generator 80 to divide the time axis at predetermined intervals, wherein the time interval of the time axis can be determined according to the DCCT information or the EIT information.

Meanwhile, the controller 90 operates to cause the user setting information input or selected by a user, to be stored. When the controller 90 receives the DCCT information, the controller 90 automatically changes a channel into a virtual channel on the basis of a command in the DCCT when the stored user setting information is equal to the DCCT information.

Here, many changeable virtual channels maybe provided. In this case, a changeable channel list or changeable channel information can be displayed allowing a user to select a desired channel, or a first changeable virtual channel can be selected among many changeable virtual channels. The controller 90 will be described later in more detail.

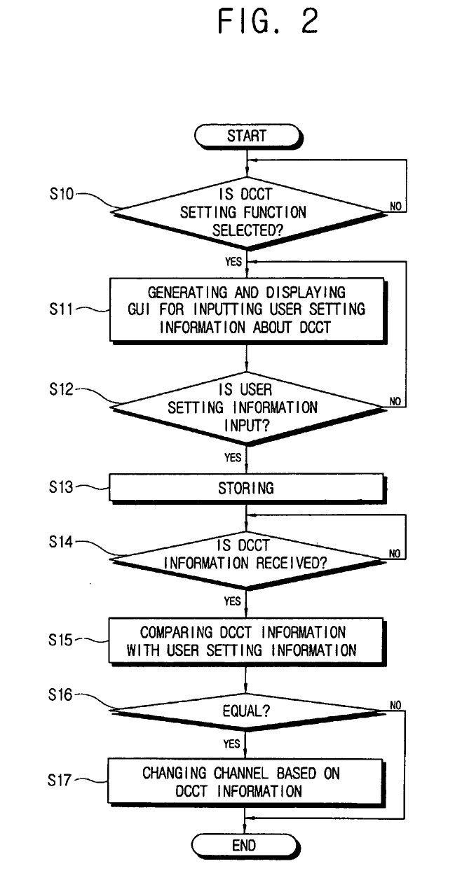

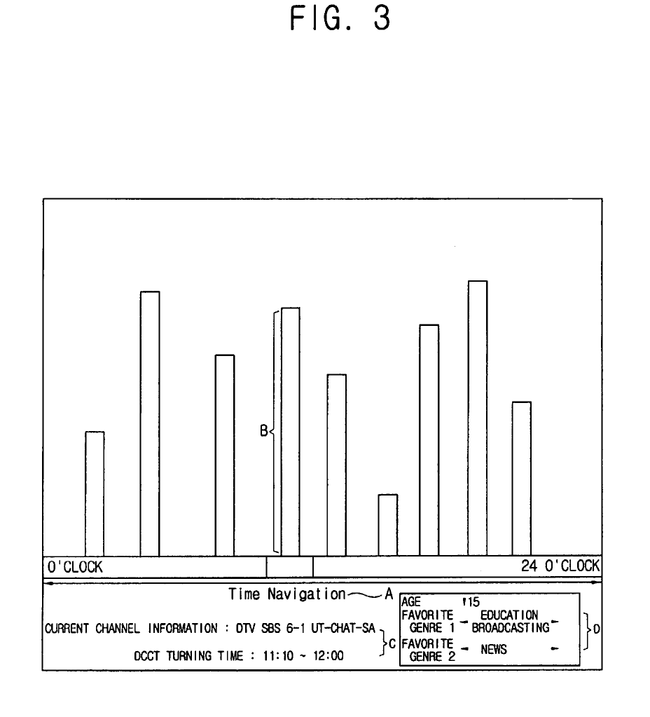

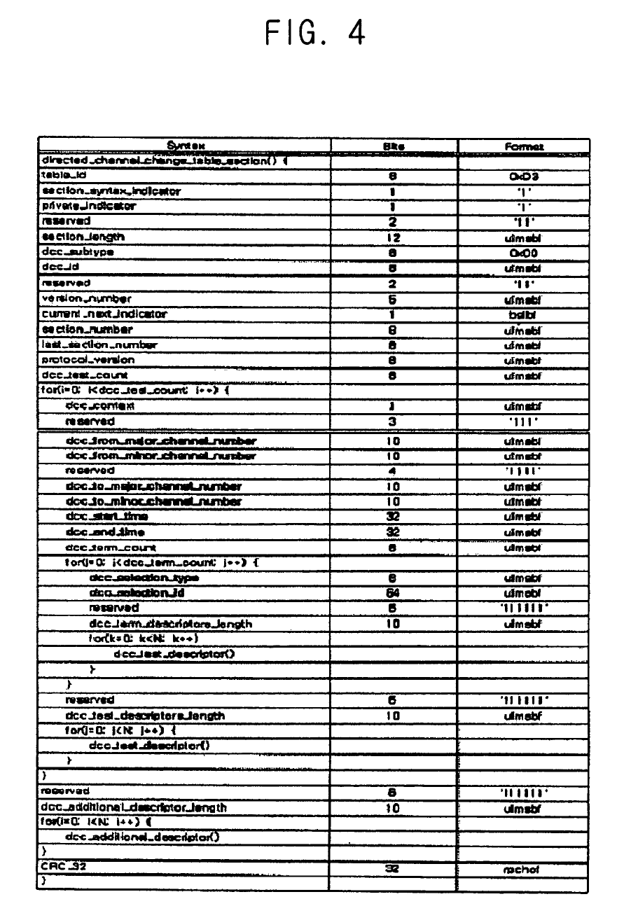

A method of controlling the digital television according to the first embodiment of the present invention will be described with reference to FIGS. 2 through 4. FIG. 2 is a control flowchart of the digital television according to the first embodiment of the present invention; FIG. 3 illustrates a DCCT set menu according to the first embodiment of the present invention; and FIG. 4 illustrates a DCCT transmitted to the digital television according to the first embodiment of the present invention.

As shown in FIG. 2, if a DCCT setting function is selected through the user selection unit 70 at operation S10, the controller 90, at operation S11, receives a corresponding key signal, and controls the GUI generator 80 to generate the DCCT set menu.

Here, the DCCT set menu generated by the GUI generator 80 has a time axis, and the time axis is divided according to predetermined time periods, thereby allowing a user to input the user setting information corresponding to the divided time.

As shown in FIG. 3, the DCCT set menu generated by the GUI generator 80 uses 24 hour abscissa as the time axis. By manipulating the user selection unit 70, a time navigation bar of the region labeled ‘A’ region can move left and right on the time axis, and move up and down to change the channel.

Further, an ordinate length, or height, of a bar graph ‘B’ is adjusted according to the length of each divided time. As alternatives to the bar graph and the abscissa and/or ordinate time axis, various other methods can be used as long as a user can recognize the interval of the corresponding time.

As described above, the time interval can be represented in various ways according to the DCCT information or the EIT information. That is, the GUI is provided for allowing a user to set the user setting information according to the DCCT information or the EIT information by dividing hours on the basis of the start time and the end time of the corresponding program. For example, when the program having the DCCT information is scheduled at 8:00˜9:00 AM, 11:00˜11:30 AM, 2:20˜4:00 PM, etc., the time scale is divided and represented according to the start and end times of the corresponding programs. Thus, a user can input the setting information differently according to the time.

In FIG. 3, the time navigation is set depending on the EIT information, so that a user can input or select the user setting information corresponding to a desired time by moving the time navigation bar using the user selection unit 70. For example, when a user moves the time navigation bar to ten minutes past eleven o'clock, channel information corresponding to the selection of the time navigation is displayed in the region denoted ‘C’ in FIG. 3. Referring to FIG. 3, a channel number, a program title, a start time and an end time are displayed in the ‘C’ region.

Further, items for inputting the user setting information about the DCCT are displayed in the region denoted ‘D’. Here, a user can select desired age information, desired genre information, etc. through the use of user selection unit 70. In FIG. 3, the age information and the genre information are illustrated as selectable information, but the invention is not limited to displaying only those types of information. Alternatively, local information, population information, etc. may be displayed as the selectable information.

When a user sets the selectable information displayed in the ‘D’ region at operation S12, the controller 90 controls a predetermined memory (not shown) to store the set information therein at operation S13.

At operation S14, the controller 90 determines whether the received PSIP information includes the DCCT information. When the received PSIP information includes the DCCT information, at operation S15 the controller 90 parses the DCCT information and compares the parsed DCCT information with the user setting information stored in the memory. Here, the controller 90 checks the user setting information for the time corresponding to the start time of the DCCT, and compares the DCCT information with the user setting information.

Referring to the DCCT information shown in FIG. 4, if a value set by a user is determined in operation S 16 to be identical (Evaluation True) with dcc_selection_id for each dcc_selection type while a user watches virtual channels corresponding to a dcc_from_major_channel_number and a dcc_from_minor_channel_number, the controller 90, in operation S17, controls the channel to be changed to the virtual channels corresponding to the dcc_from_major_channel_number and the dcc_from_minor_channel_number at a dcc_start time. The virtual channel is then returned to the original channel.

A dcc mode is stopped when a user selects another channel before returning to the original channel or when a table (dcc_selection_type=0×0F) for stopping the dcc mode is received.

The dcc_selection_type is variously defined. For example, in the case of the postal code, the dcc_selection_type includes 0×01, 0×02, 0×11 and 0×12. In this case, a dcc_selection_id is a postal code value, and operates according to types. Besides, the dcc_selection_type related to the DCCT includes the local information (0×0C, 0×1C), the population information (0×05, 0×06, 0×5, 0×16), and the genre information (0×07, 0×08, 0×17, 0×18). Thus, the controller 90 operates to change to the corresponding channel if the DCCT information is identical with the user information. On the other hand, if the DCCT information is not identical to the user information, the DCCT is disabled.

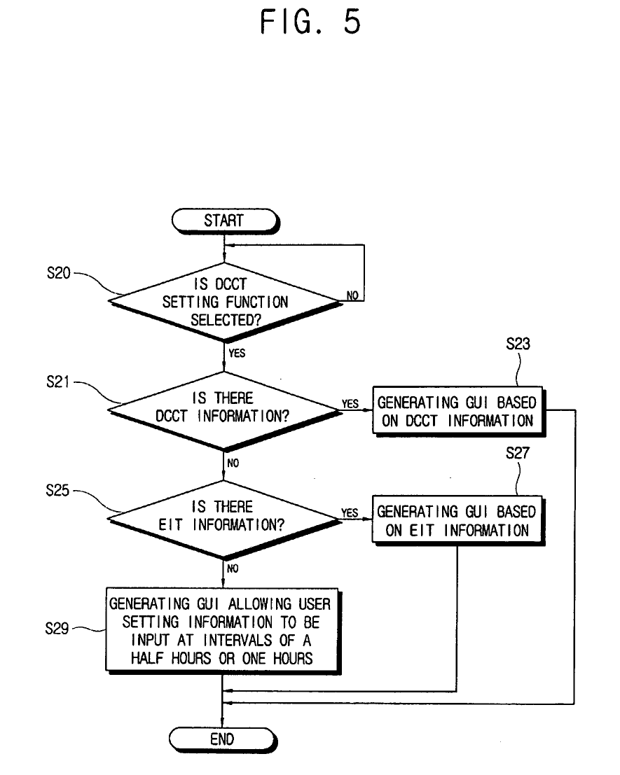

Below, a method of controlling a digital television according to the second embodiment of the present invention will be described with reference to FIG. 5, wherein repetitive descriptions will be avoided as necessary.

As shown in FIG. 5, in operation S20 when the DCCT setting function is selected through the user selection unit 70, the controller 90 determines, in operation S21, whether the DCCT information is present. As described above, the PSIP information is stored in the memory. Therefore, the foregoing determination depends on the DCCT information stored in the memory.

If the DCCT information is present, the controller 90, at operation S23, controls the GUI generator 80 to divide the time axis according to the start time and the end time of the program as specified in the DCCT information, thereby generating the DCCT set menu.

On the other hand, if no DCCT information is present, the controller 90, at operation S25, determines whether the EIT information is present. In the case where the EIT information is present, the controller 90, at operation S27, controls the GUI generator 80 to divide the time axis of according to the start time and the end of the program specified in the EIT information, thereby generating the DCCT set menu.

In the case where there is no EIT information, the controller 90, at operation S29, controls the GUI generator 80 to divide the time axis according to intervals of a predetermined fixed time such as a half hour, one hour, etc, thereby generating the DCCT set menu. Here, the time intervals can be set by a user. Further, the following control flow according to the second embodiment is the same as for the first embodiment. Thus, a user can set the user setting information about the DCCT according to the time.

As described above, the present invention provides a digital television and a method of changing a channel thereof, in which user setting information about a DCCT can be set in various ways according to time, thereby improving a user's convenience.

Although a few embodiments of the present invention have been shown and described, it will be appreciated by those skilled in the art that changes may be made to these embodiments without departing from the principles and spirit of the invention, the scope of which is defined in the appended claims and their equivalents.

What is claimed is:

1. A method of changing a digital television channel on the basis of direct channel change table (DCCT) information, the method comprising:
generating a graphical user interface (GULI) for inputting information concerning the DCCT, the information being set by a user according to a predetermined time;
storing the user-set information concerning the DCCT; and
comparing the DCCT information with the user-set DCCT information, and changing to a predetermined channel based on the DCCT information if the DCCT information is equal to the user-set information.

2. The method according to claim 1, wherein the GUI is generated to include a time axis to allow the user-set information to be input according to time and based on predetermined information.

3. The method according to claim 2, wherein the GUI is generated to allow the user-set information to be input according to time and based on the DCCT information.

4. The method according to claim 2, wherein the GUI is generated to allow the user-set information to be input according to time and based on event information table (EIT) information.

5. A digital television having a receiver to receive data and a decoder to decode the received data, the digital television comprising:
a GUI generator configured to generate a direct channel change table (DCCT) set menu allowing user setting information about the DCCT to be input according to a predetermined time; and
a controller configured to compare the input DCCT information with the input user-set information, and to generate a control signal to change to a predetermined channel based on the DCCT information if the DCCT information is equal to the user setting information.

6. A method of changing a digital television channel on the basis of received channel changing information, the method comprising:
generating a graphical user interface (GUI) for facilitating user input for setting channel changing information, wherein the channel changing information is associated with a predetermined time;
storing the user-set channel changing information in a memory; and
comparing the received channel changing information with the stored user-set channel changing information, and changing to a predetermined channel based on the received channel changing information if the received channel changing information compares with the stored user-set channel changing information.

7. The method according to claim 6, wherein the channel changing information is a direct channel change table (DCCT).

8. The method according to claim 7, wherein the changing to a predetermined channel occurs if the received channel changing information equals the stored user-set channel changing information.

9. The method according to claim 6, wherein the GUI is generated to include a time axis for facilitating the user setting the channel changing information based on the associated time and based on predetermined information.

10. The method according to claim 9, wherein the predetermined information is direct channel change table (DCCT) information stored in the memory.

11. The method according to claim 9, wherein the predetermined information is event information table (EIT) information stored in the memory.
